(19) United States
(12) Patent Application Publication
(10) Pub. No.: US 2023/0280835 A1
(43) Pub. Date: Sep. 7, 2023

(54) SYSTEM INCLUDING A DEVICE FOR PERSONALIZED HAND GESTURE MONITORING

(71) Applicants: Mozest Goldberg, Les Baux de Provence (FR); Arizona Board of Regents on Behalf of Arizona State University, Tempe, AZ (US)

(72) Inventors: Troy McDaniel, Gilbert, AZ (US); Mozest Goldberg, Les Baux de Provence (FR); Sethuraman Panchanathan, Gilbert, AZ (US)

(21) Appl. No.: 18/004,219

(22) PCT Filed: Jul. 12, 2021
(86) PCT No.: PCT/US2021/041282

§ 371 Date: Jan. 4, 2023

Related U.S. Application Data
(60) Provisional application No. 63/050,581, filed on Jul. 10, 2020.

(51) Int. Cl. G06F 3/01; G06F 3/0346; G06V 40/20

(52) U.S. Cl. CPC G06F 3/017; G06F 3/0346; G06V 40/28

(57) ABSTRACT

Embodiments of a lightweight unobtrusive wearable device which is operable to continually monitor an instantaneous hand pose are disclosed. In some embodiments, the device measures the position of the wrist relative to one's body and the configuration of the hand. The device may infer hand pose in real-time and, as such, can be combined with actuators or displays to provide instantaneous feedback to the user. The device may be worn on the wrist and all processing can be performed within the device, thus addressing privacy.

### CROSS REFERENCE TO RELATED APPLICATIONS

The present PCT patent application claims the benefit of provisional patent application No. 63/050,581 filed on Jul. 10, 2020, which is hereby incorporated by reference to its entirety.

### FIELD

The present disclosure generally relates to the fields of wearable computing, multimodal processing, and gesture recognition; and in particular, the present disclosure relates to a system including a device and methods that may be wearable along the wrist for monitoring dynamic hand gestures as would be employed for example in user interfaces to other devices, user interaction in virtual worlds, and for neurological diagnostics.

### BACKGROUND

Much of human activity requires and revolves around the use of our hands; however, we do not use hands only to interact with our environment in a physical manner, we also employ our hands when we communicate. Infants communicate with their hands well before using speech; for example, beginning around the age of 10 months they will start to point to objects and can be taught to use signing or symbolic gestures well before talking. Sometime, around 18 months, infants will use gestures at the same time as speech. For example, while pointing at a cat they will say “cat”. As we grow older, these gestures most often remain with us at a subconscious level. When we provide direction, our hands naturally move in concord with the direction indicated.

It is with these observations in mind, among others, that various aspects of the present disclosure were conceived and developed.

### SUMMARY

In one example, the present inventive concept takes the form of a system for inferring hand pose and movement including a device positioned along the wrist of a user's hand. The device includes at least one camera and at least one sensor including an inertial measurement unit (IMU) in operable communication with a processor. The processor is configured to (i) access a plurality of multimodal datasets, each of the plurality of multimodal datasets comprising a video data stream from the camera and an IMU data stream from the IMU, (ii) extract a set of features from each of the video data stream and the IMU data stream, (iii) applying the set of features in combination to a machine learning model to output a gesture, perform at least one iteration of steps (i)-(iii) to train the machine learning model, and perform, in real-time, at least one additional iteration of steps (i)-(iii) to infer a pose of the hand relative to a body of the user including a position of fingers of the hand at a given time. The camera of the system may include at least two cameras to generate the video data stream: a first camera positioned along a dorsal side of the wrist, and a second camera positioned along the ventral side of the wrist.

In some examples, the processor calculates a change between a number of the set of features to identify a classification of the fingers related to the pose. In some examples, the processor corrects positional errors associated with the IMU by exploiting extracted views of a head of the user, the views of a head of the user defined by the video data stream. In some examples, the IMU data stream includes accelerometery and motion data provided by the IMU, and the video data stream includes video or image data associated with views of fingers of the hand.

In some examples, the video data stream includes wrist-centric views extracted by the camera including a view of finger tips of the hand, abductor pollicis longus of muscle of the hand which pull in a thumb of the hand for grasping, and a size of a channel defined between a hypothenar and thenar eminences associated with the hand. In some examples, the system includes a mobile platform in communication with the device operable to display feedback and provide real-time guidance to the user.

In one example, the present inventive concept takes the form of a method inferring hand pose and movement, comprising steps of: training a machine learning model implemented by a processor of a device positioned along a wrist defined along a hand of a user to provide an output that adapts to the user over time, by: accessing a first multimodal dataset comprising a first video data stream from a camera of the device and a first IMU data stream from an IMU of the device as the user performs a predetermined set of gestures, extracting a first set of features collectively from each of the first video data stream and the first IMU data stream, and applying the first set of features in combination to the machine learning model to output a gesture; and inferring a gesture based upon a pose of the hand by: accessing a second multimodal dataset comprising a second video data stream from the camera of the device and a second IMU data stream from the IMU of the device, extracting a second set of features collectively from each of the second video data stream and the second IMU data stream, and applying the second set of features to the machine learning model as trained to output the gesture. The camera of the method may include at least two cameras to generate the video data stream: a first camera positioned along a dorsal side of the wrist, and a second camera positioned along the ventral side of the wrist.

In some examples, the method includes executing by the processor a neural network as the user is prompted to perform a predetermined set of stereotypical movements to train the processor to interpret a fixed morphology and movements unique to the user. In some examples, the method includes interpreting, by the processor, motion data directly from the first IMU data stream and the second IMU data stream. In some examples, the method includes inferring by the processor in view of the second video data stream a position of the hand relative to a body of the user by identifying a position on a face of the user to which the hand is pointing. In some examples, the method includes tracking subsequent movements of the hand according to pre-set goals associated with predefined indices of compliance. In some examples, the method includes inferring by the processor in view of the second video data stream a pointing gesture from the hand, the pointing gesture directed at a connected device in operable communication with the device positioned along the wrist of the user. The pointing gesture is interpretable by the processor as an instruction to select the connected device for a predetermined control operation. In some examples, the method includes inferring by the processor in view of the second video data stream a control gesture subsequent to the pointing gesture, the control gesture indicative of an intended control instruction for transmission from the device along the wrist to the connected device; such as where the connected device is a light device and the control gesture defines an instruction to engage a power switch of the light device. The connected device may also be a robotic device, such that the control gesture defines an instruction to move the robotic device to a desired position. In some examples, the method includes accessing information from a pill box in operable communication with the processor, the information indicating that the pill box was opened at a first time and closed at a second time after the first time by the user, and accessing by the processor in view of the second video data stream a consumption gesture made by the user reflecting a consumption of a pill from a plurality of pills stored in the pill box.

In one example, the present inventive concept takes the form of a system for personalized hand gesture monitoring, comprising a device positioned proximate to a hand of a user, comprising: a plurality of cameras that capture image data associated with a hand of the user including a first camera that captures a first portion of the image data along a ventral side of a wrist of the user and a second camera that captures a second portion of the image data along a dorsal side of the wrist of the user; at least one sensor that provides sensor data including a position and movement of the device; and a processor that accesses image data from the plurality of cameras and sensor data from the at least one sensor to train a model to interpret a plurality of gestures, and identify a gesture of the plurality of gestures by implementing the model as trained.

In this example, the model may include a neural network, and the model may be trained or calibrated by feeding the model with video stream data from the plurality of cameras as the user performs a set of stereotypical movements. In this example, features may be extracted from the video stream data and also sensor data streams such as IMU data from the at least one sensor, and features from each stream may be combined and used to classify and identify a plurality of gestures. In general for example, a user is asked to perform a set of stereotypical movements including ones where images of the head are captured. The IMU data stream and the video data stream generated the use's performance of the set of stereotypical movements can be used as templates for classical video processing algorithms or as training data for a convolutional neural network (CNN), or other such machine learning model. Once each of the IMU data stream and the video data stream is processed as described to extract or otherwise derive features, the features may then be further process under the gesture recognition pipeline. More specifically for example, a first process may be performed where the processor calculates the change between a number of extracted features of the finger and classifies the pose; fingers are respectively, closing up, opening up, remaining stationary or fully open. In an analogous manner, a second process may be performed by the processor to calculate the change in the APL muscle and the channel between the hypothenar and thenar enminences. When the channel reaches its typical minimum value and the AP its typical maximum volume, the process classifies the pose as one of prehension. Conversely, when the channel is maximum and the APL is minimum, the thumb is in its relaxed position.

In one example, the present inventive concept takes the form of tangible, non-transitory, computer-readable media or memory having instructions encoded thereon, such that a processor executing the instructions is operable to: access a multimodal dataset based on information from an IMU and a camera positioned along a hand of a body of a user; and infer a position of the hand relative to the body by extracting features from the multimodal dataset, and applying the features to a predetermined machine learning model configured to predict a gesture. The processor executing the instructions is further operable to train with the predetermined machine learning model as the user is prompted to perform a predetermined set of movements such that the processor executing the predetermined machine learning model is further configured to provide an output that adapts to the user over time.

### BRIEF DESCRIPTION OF THE DRAWINGS

FIG. 1 is an illustration of the ventral side of the hand with the present wrist device held in place by a band. As indicted, all five fingers are extended and viewable by a camera.

FIG. 2 is an illustration of the ventral side of the hand partially closed. All five fingers, and the highlighted thenar eminence, are viewable by the camera.

FIG. 3 is an illustration of a side view of the hand with the fingers extended backwards. The camera's view of the fingers is now obstructed by the thenar and hypothenar eminences—the two bulges at the base of the palm.

FIG. 4 is an illustration of the ventral side of the hand with the fingers closed and the thumb extended backwards. The camera's view of the thumb is obstructed by the hypothenar eminences—the bulge at the base of the thumb—the other four fingers are still viewable.

FIG. 5A is a simplified block diagram of a system overview of possible hardware architecture for the device described herein.

FIG. 5B is an illustration of one embodiment of the device described herein that may be worn about the wrist.

FIG. 6 is a simplified block diagram of an exemplary gesture recognition processing pipeline associated with the wrist device described herein.

FIG. 7 is a simplified block diagram of an exemplary mobile platform and application for use with the wrist device described herein.

FIG. 8 is a simplified block diagram of an exemplary method for implementing the device described herein to infer hand pose.

FIGS. 9A-9B are illustrations demonstrating possible gestures, positions, and orientations of the hand of the user interpretable by the wrist device to control or interact with a separate connected device.

FIG. 10 is a simplified block diagram of an exemplary computer device for effectuating various functions of the present disclosure.

Corresponding reference characters indicate corresponding elements among the view of the drawings. The headings used in the figures do not limit the scope of the claims.

### DETAILED DESCRIPTION

There is benefit in exploiting the natural ability of the hands for interfacing to devices through gestures. Hand gesture dysfunction is also of interest in medicine, for example, in the detection and monitoring of syndromes such as Parkinson's and essential tremor. Accordingly, the present invention concerns an unobtrusive device, which in one non-limiting embodiment may be implemented along a wrist (e.g., as a wrist device). The present device includes at least a video camera and an inertial movement unit (IMU), and the device continuously monitors the hand and wrist movements to infer hand gestures; positions of the fingers, the orientation of the wrist, and the relative displacement of the wrist. The device may be operated using varying solutions related to gesture recognition and tremor detection algorithms to provide various functions described herein.

In some embodiments, the device operates independently in the background, and does not interfere in any way with the movements of the hands and affords the users mobility. Furthermore, the device may be wearable, and the location of the camera on the device affords direct visual access to the ventral side of the hand, including the palm. This is where much of the action involved in gesturing takes place as fingers tend mostly to move towards (flexion) and then back away (extension) from the palm of the hand. The device of the present disclosure is implemented or otherwise embodied in contradistinction to methods which rely on cameras located on other parts of the body such as the head or in the environment. The former affords the users mobility; however, there will inevitably arise “blind spots” where the gesture cannot be fully captured. In the latter, we can eliminate “blind spots” by additional cameras; however, we give up user mobility. Furthermore, in both cases, there will invariably arise occasions when the view of the ventral side of the hand is obstructed.

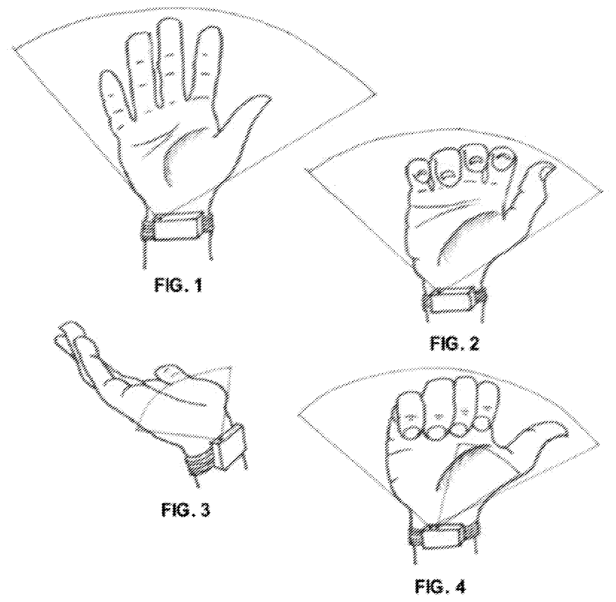

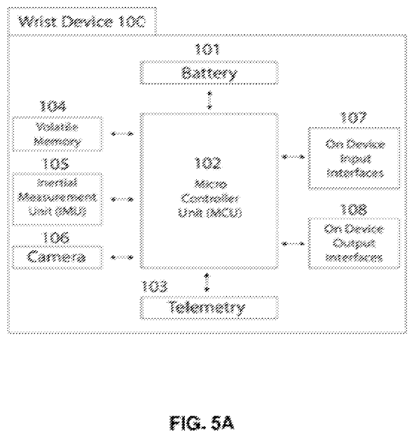

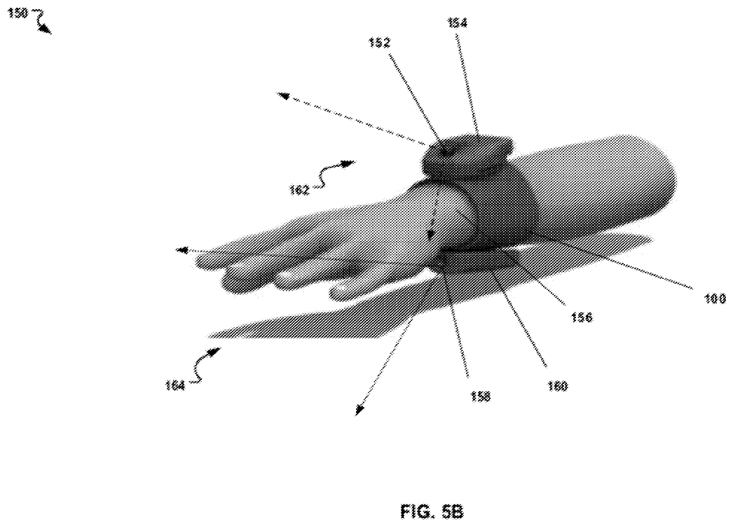

In general, the device described herein may be worn on the wrist with various electric components (FIG. 5A) contained within a watch-like housing situated on the ventral side of the wrist. A camera of the device may be located diagonally opposite the index and the thumb and angled so that the entire hand is within the field of view (e.g., FIGS. 1-2). In some embodiments, a IMU sensor of the device may also be situated on the ventral side of the wrist, within the housing, and provides a continuous stream of attitude, accelerometry and motion data.

In some embodiments one or more cameras may be positioned on the dorsal side of the wrist and the components split between housings on the ventral and dorsal sides of the wrist. These cameras can capture extensions of the hand and/or the fingers which are no longer visible to the ventral cameras (FIG. 3).

In yet other embodiments cameras with lenses may be implemented on the ventral side that are narrowly focused with regards to the field and depth of view, so as to minimize distortions and improve resolution. For example, we may want a camera to focus on the thenar eminence wherein lie the three muscles that control the fine movements of the thumb (FIG. 4) The thenar eminence is situated in close proximity to the camera; therefore, we would expect the camera as shown in FIG. 1 to yield a distorted view of this area. As the thumb flexes, extends and rotates, corresponding changes in its shape are clearly visible and if correctly imaged could be used for diagnostic purposes.

In some embodiments, for example, if the device is to be deployed in poorly lighted environments, cameras with incorporated LED light sources or operating with infrared detectors may be used.

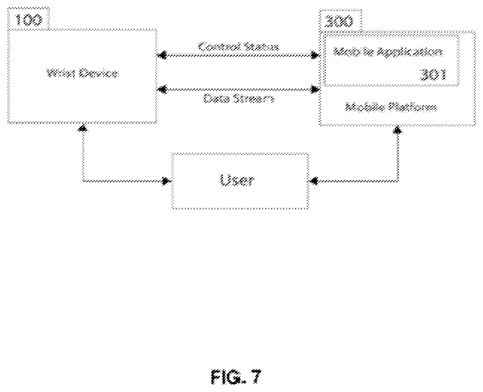

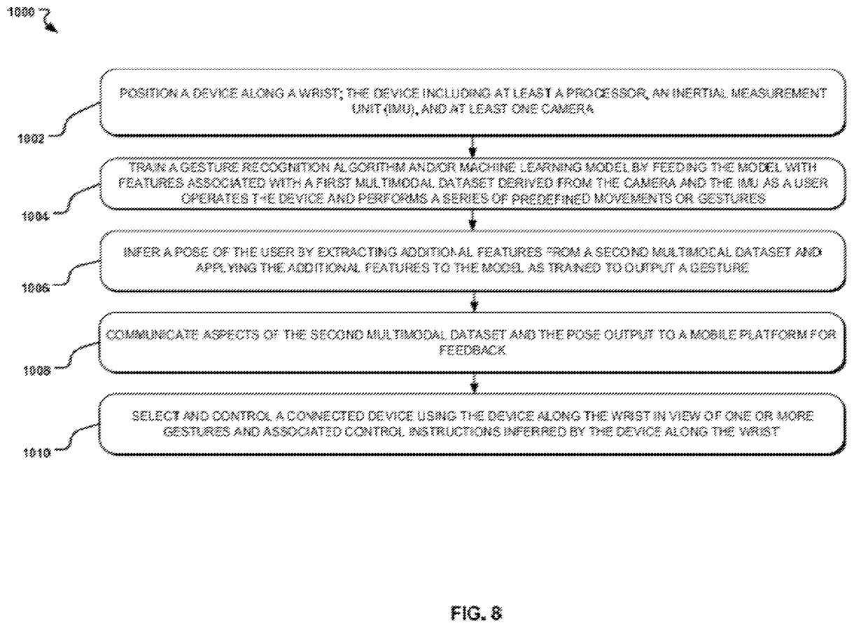

In some embodiments, the device operates in conjunction with an application (301 in FIG. 7). In the initialisation phase, the application supplies a database of gestures that a user may perform and this database of gestures is used by the device to train and optimise the on-board gesture recognition algorithm. The device employs one of well-known gesture recognition algorithms and training techniques that run within the on-board processors. The device continually monitors the user's hand employing at least one camera and the IMU. In real-time the on-board processors determine whether the user is gesturing and if the gestures is one occurring in the database provided by the application. Whenever a match is found, the application is informed.

In some embodiments, the device communicates with the application using, but not limited to, wireless technology such as, WiFi or Bluetooth. The application itself may reside on computing devices such as, but not limited to, smartwatches, smartphone, or tablets, and, alternatively, may be embedded within other intelligent devices such as, but not limited to, robots, autonomous vehicles, or drones. In other embodiments the device itself is embedded within a smartwatch and gestures could be used to operate the smartwatch or any other external device.

In other embodiments the device may be employed in sign language translation by acting as an input and prefiltering device for sign language translation software. There is interest in employing smartphone technology, wherein the camera of the smartphone is positioned in front of the signer so as to capture the hand gestures. The video data is then analyzed by one of the many well-known algorithms for sign language translation, with the voice being sent to the smartphone speakers. The wrist wearable setup offered by the device offers a number of significant novel advantages: it affords complete mobility to both the speaker and listener, the speaker's hand gestures can be more discreet, and it can function in a variety of lighting conditions.

In yet other embodiments where real-time gesture recognition is not a requirement, the sensor data, possibly fully or partially processed, may be stored in on-board memory for subsequent upload to a web server or application. Such a device could be worn by a subject in vivo over an extended period and employed for monitoring hand tremors in syndromes such as, but not limited to, essential tremor, Parkinson's, and gesture-like movements in hand/finger rehabilitation. The clinician and physiotherapist need only provide, respectively, examples of tremor or hand/finger exercises to be monitored. These would be placed in the database and used to train the gesture recognition algorithm.

### Exemplary Hardware Components

Referring to FIG. 5, a hardware architecture of a wrist device 100 may include various hardware components. In general, the wrist device (100) is built around a Microcontroller Unit (MCU) (102) which connects the sensory modules (105,106) and manages on-device user interactions through the onboard input and output interfaces (110,120). As shown in FIG. 7, the MCU (102) communicates with a mobile application (301) executable on a smartphone or other mobile platform (300) by way of the telemetry unit (103).

### Wrist Device (100)

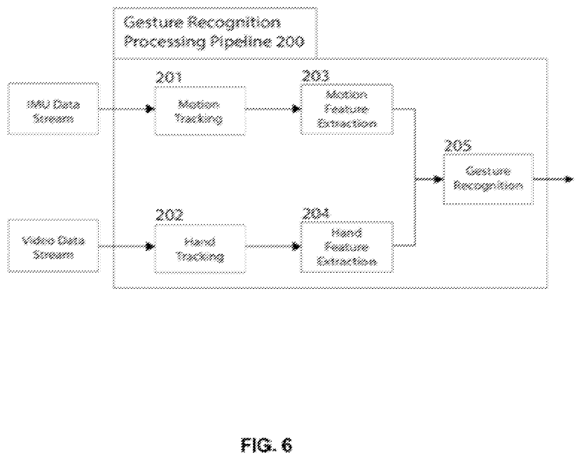

Further non-limiting detail regarding possible hardware components and possible features of the wrist device 100 include the following:
Battery (101): The device may be powered by a rechargeable battery;
Microcontroller Unit (MCU) or “processor” (102): The MCU may include processing units, such as accelerators, and non-volatile memory to execute in real-time the requisite data processing pipeline; e.g., the pipeline shown in FIG. 6;
Telemetry (103): Bluetooth may be employed to communicate with external devices;
Volatile memory (104): The volatile memory unit may be employed for housekeeping purposes, storing the parameters for the Gesture Recognition Processor Pipeline (200) and to record recent user gestural command activities;
Inertial measurement unit (IMU) (105): The (IMU) may be included to provide data on linear acceleration, angular velocity, and the magnetic field strength;
Ventral Camera (106): In some embodiments, the camera 106 may be located at the front of the device 100 diagonally opposite the index and the thumb and angled so that the entire hand is within the field of view, as shown in FIG. 1 and FIG. 2;
On device input interfaces (107): Versions of the device 100 may include, but are not limited to, buttons, switches, a microphone for voice command input, and/or touch sensitive screens and combinations thereof; and
On device output interfaces (108): Versions of the device 100 may include, but are not limited to embodiments with LED lights, display screens, speakers, and/or haptic motors or combinations thereof.
   Embodiments of Wrist Device with Multiple Cameras

Referring to FIG. 5B, in one embodiment (150), the device 100 includes two or more cameras; specifically, a first camera 152 of a first housing 154 of the device 100 positioned on the dorsal side of the wrist 156 of a user, and a second camera 158 of a second housing 160 of the device 100 positioned along a ventral side of the wrist 156. In these embodiments, the hardware components of the device 100 may be split between the first housing 154 and the second housing 160 on the ventral and dorsal sides, respectively, of the wrist 156. The first camera 152 and the second camera 158 can capture image data that fully encompasses a pose of the whole or entire hand, including both sides of the hand, the thumb, and fingers. As illustrated for example, using the first camera, the 152, the embodiment 150 of the device 100 provides a field of view (FOV) 162 that captures image data along the dorsal side of the wrist 156, and the second camera 158 provides another FOV 164 that captures image data along the ventral side of the wrist 156.

### Gesture Recognition Processing Pipeline (200)

Referring to FIG. 6, in some embodiments, the device may employ one or more gesture recognition algorithms and training techniques with one possible modification. In the standard technique, motion data needs to be computed from the video data, whereas with the present device the motion data may be obtained or otherwise interpreted directly from the IMU (105). With the processing pipeline (200) shown, we see two separate streams, one for tracking the motion (201) and the second for the hand (202). Features extracted (203, 204), respectively, from each stream may be combined and used to classify and identify the gestures (205).

In general, under the gesture recognition pipeline (200), the IMU (105) provides IMU stream data including accelerometry and motion data; whereas, the camera (106) provides a video data stream including video data that includes images with possibly partial views of the fingers, the abductor pollicis longus (APL) muscle, the channel between the hypothenar and thenar enminences and the head. This raw video data may be time-stamped and be transmitted to one or more processors to extract the different features from the IMU data stream and the video data stream.

In some embodiments, an initialization phase is implemented that involves the customization of the device (100), specifically, the processor (102) to the individual's morphology and stereotypical movements. In general for example, a user is asked to perform a set of stereotypical movements including ones where images of the head are captured. The IMU data stream and the video data stream generated the use's performance of the set of stereotypical movements can be used as templates for classical video processing algorithms or as training data for a convolutional neural network (CNN), or other such machine learning model.

Once each of the IMU data stream and the video data stream is processed as described to extract or otherwise derive features, the features may then be further process under the gesture recognition pipeline (200). More specifically for example, a first process may be performed where the processor (102) calculates the change between a number of extracted features of the finger and classifies the pose; fingers are respectively, closing up, opening up, remaining stationary or fully open. In an analogous manner, a second process may be performed by the processor (102) to calculate the change in the APL muscle and the channel between the hypothenar and thenar enminences. When the channel reaches its typical minimum value and the AP its typical maximum volume, the process classifies the pose as one of prehension. Conversely, when the channel is maximum and the APL is minimum, the thumb is in its relaxed position.

The accelerometry and motion data from the IMU (105) provides a continuous estimate of the current position of the wrist; however, the readings suffer from drift resulting in increasing positional errors. A third process may be performed by the processor (102) to correct these positional errors by exploiting the extracted views of the head. The extracted views may be compared with the previously captured templates and employing some simple geometry the relative position can be estimated. If a range finding sensor is available this can also be incorporated to reduce the margin of error.

In some embodiments, the raw IMU data may be pre-processed by one of the many well-established algorithms to estimate the position, velocity, acceleration and orientation. Features that are typically extracted from these estimates include directional information, the path traced by the wrist, and the acceleration profile. These by themselves may suffice to identify the gesture; for example, 90 degrees rotation of the wrist could signify “open the door”.

The video data is first processed frame-by-frame using one or more of any algorithms for hand tracking. The frame undergoes some well-known algorithm for noise removal and image enhancement. The next step involves extracting the hand from the background. The close and constant proximity of the wrist cameras to the hand facilitates the task as the background will be out of focus and the hand can be illuminated from light sources co-located with the cameras. One of the many well-established algorithms for thresholding, edge following, and contour filling is employed to identify the outline of the hand.

Hand feature extraction then follows and falls into one of two categories: static and dynamic. The former is derived from a single frame, whereas, the latter involves features from a set of frames. One of the many well-established algorithms can be employed and typically involves the status of the fingers and the palm. Examples include index finger or thumb extended and other fingers closed; all fingers extended or closed; motion of the extended hand relative to the wrist; hand closing into a fist; to name but a few. The Gesture Recognition module (205) then employs the features thus derived in the IMU and the Video pipelines.

When a set of “exercise” or other predetermined/desired movements are prescribed, gesture recognition pipeline (200), or a general pose inference engine, can be implemented by the processor (102) to calculate the difference between the actual and prescribed movements and these differences may be reported to a third party application (e.g., 301).

Consider the situation where the device (100) is employed to control a light dimmer where the gesture to be identified is a cupped hand moving, respectively, upwards or downwards. The cupped hand is identified by extracted features from the visual stream and the corresponding motion of the wrist by extracted features from the IMU stream; the two sets are then combined to identify the required action on the dimmer. In a second example, the device (100) may be used for a virtual reality world wherein the attitude (heading, pitch and yaw) of a drone is to be controlled by gestures. In some embodiments, the device (100) includes an additional dorsal camera.

Numerous non-limiting novel features are contemplated by the present disclosure. For example, one feature of the device (100) is that it uses both IMU and wrist-centric video views of the hand to generate multimodal data sets: these would include (1) finger tips, (2) the abductor pollicis longus muscle which pull in the thumb for grasping, and (3) the size of channel between the hypothenar and thenar eminences.

Another features is the customization of the device (100) to the individual's fixed morphology and stereotypical movements. The customization is achieved through software. The user is asked to perform a set of stereotypical movements, which are used to train a convolutional neural network.

Another feature includes the manner in which body relative position is inferred. Over time an IMU needs to be recalibrated as the positional data becomes unreliable. It is well know that our hands tend to constantly move around often pointing to the our body in general and very frequently to our heads. In the latter instance we can infer the position relative to the body by using the video data to identify the position on the face to which the hand is pointing.

Another feature is the ability to track hand movements accurately and to compare these with pre-set goals, thus deriving various indices of compliance. Yet another feature is that the device can be linked to third party application devices which interact with users through actuators or on-board displays to provide real-time guidance.

### Mobile Application (301)

Referring to FIG. 7, in some embodiments, at setup, the set of gestures specified by the application (301) are transmitted to the Wrist Device (100) via the mobile platform (300) as shown, and the user is requested to repeat these gestures so that the Wrist Device (100) can be personalized. The associated IMU and video streams are transmitted to the application (301) via the mobile platform (300). Employing one of well-known techniques, the Gesture Recognition algorithm undergoes training and the resultant parameters are provided to the Wrist Device (100) via the mobile platform (300) to be loaded into Gesture Recognition Processor Pipeline (200). The mobile platform 300 may include any device equipped with sufficient processing elements to operatively communicate with the wrist device 100 in the manner described, including, e.g., a mobile phone, smartphone, laptop, general computing device, tablet and the like.

In some embodiments, the user can initiate gesture monitoring, capture and recognition either through the Wrist Device (100) or through the mobile application (301) that in turn wakes up the Wrist Device (100). When a gesture is recognized, the Wrist Device (100) may transmit a control command directly to an external device or simply inform the application (301).

Referring to FIG. 8, an exemplary process or method 1000 for implementing at least some aspects of the wrist device (100) is shown. Referring to block 1002 of the method 1000, the device (100) is positioned along a hand of a user (e.g., FIG. 1). As indicated herein, the device (100) generally includes at least an IMU (105) and a camera (106) in operative communication with a processor or microcontroller (102).

Referring to block 1004, during an initialization or training phase, a user may be prompted to perform a series of predetermined movements or gestures while the user wears the device (100) along the user's wrist in the manner shown in FIG. 1-5. During this phase, at least one initial or first multimodal data set, comprising at least one video data stream and at least one IMU data stream is fed to the gesture recognition algorithm/pipeline 200 or some machine learning model such as a neural network to train the model/algorithm based on the unique biology of the user.

Referring to block 1006, the user, while wearing the device (100) in the manner indicated, can be monitored post initializing/training to assess possible hand poses/gestures. In particular as indicated, the device (100) may access at least one additional or second multimodal dataset and associated features may be applied to the model as trained to output some predicted gesture and/or pose that the user is intending to perform.

Referring to block 1008, the device as indicated herein may be in operable communication with a mobile platform (300), which may be used to display feedback or results of the training or pose prediction functions, may be used to prompt the user, and the like.

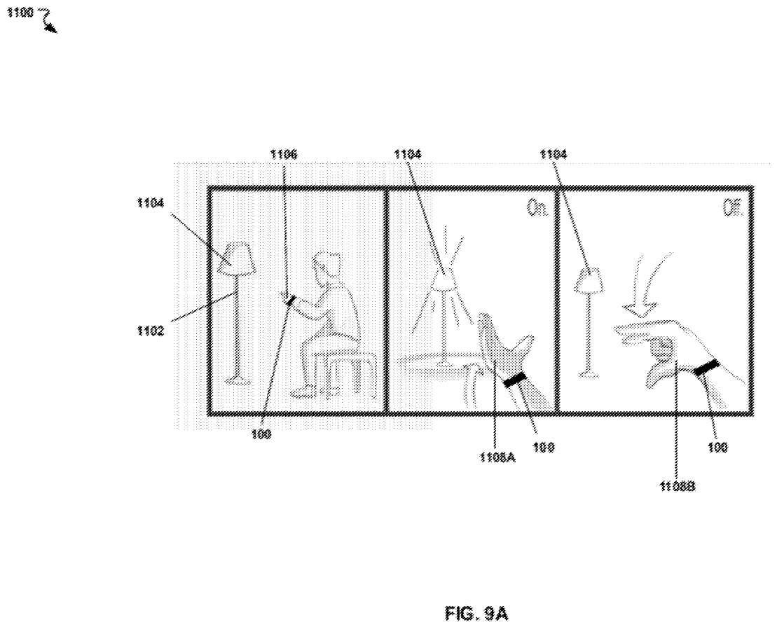

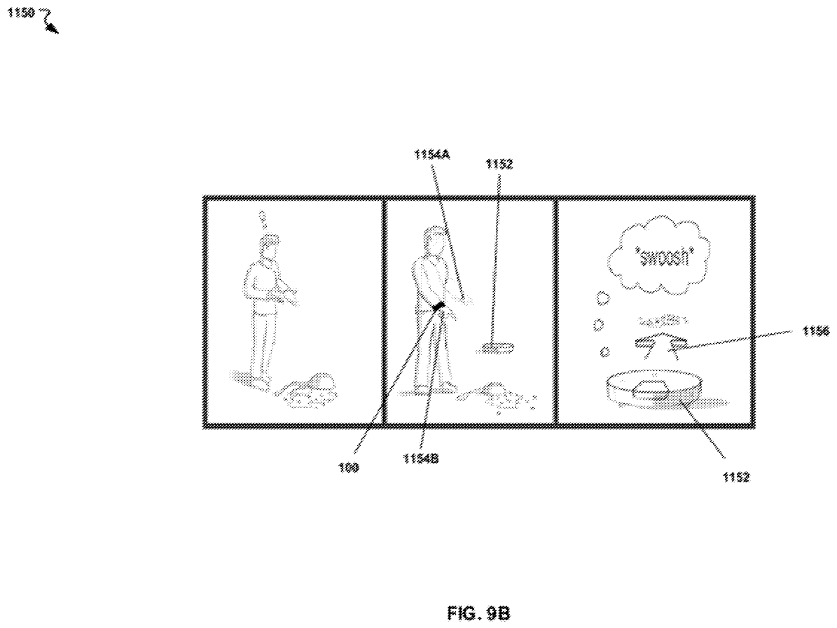

In addition, referring to block 1010 and an illustration 1100 of FIG. 9A, the device 100 may optionally be leveraged to control or otherwise interact with a separate connected device; i.e., another device connected to the device 100 in some form, via Bluetooth, RFID, Wi-Fi, or other wireless protocol or communication medium. For example, a light device 1102 (such as a lamp, electrical outlet, and the like), that includes a power switch 1104 for engaging or disengaging power, may be in operable communication with the device 100 via the telemetry unit 103 or otherwise, such that the light device 1102 is a connected device. In the present example, the device 100 is configured, via functionality described herein, to infer by the processor (102) in view of video data streams captured by the device 100, a pointing gesture 1106 from the hand proximate the device 100, the pointing gesture 1106 directed at the connected light device 1102. The pointing gesture 1106 may be predetermined or interpretable by the device 100 as an instruction to select the light device 1102 for some predetermined control operation.

As further shown in FIG. 9A, the device 100 may be configured to infer by the processor (102) in view video data streams captured by the device 100 a control gesture 1108 subsequent to the pointing gesture 1106, the control gesture 1108 indicative of an intended control instruction for transmission from the device 100 to the light device 1102. In the example shown, the control gesture 1108 includes two separate control gestures; a first control gesture 1108A for engaging the power switch 1104 of the light device 1102 to power on the light device 1102, and a second control gesture 1108B to engage the power switch 1104 and turn off the light device 1102. The device 100 may train or be trained to interpret the pointing gesture 1106 and the control gestures 1108 in the manner described herein.

Referring again to block 1010 and another illustration 1150 of FIG. 9B, another example of a connected device may include a robotic device 1152, such as a self-moving robotic cleaner. As indicated, the user implementing the device 100 may interact with the robotic device 1152 by initiating a series of control gestures 1154A-1154B, instructing the robotic device (via the device 100) to move to a desired position 1156.

In yet another example, the device 100 may be in communication with a pill box or storage compartment for storing pills. In this embodiment, the device 100 accesses information from the pill box in operable communication with the processor 102 of the device. The information may indicate that the pill box was opened at a first time and closed at a second time after the first time by the user. The device 100 may further access video stream data captured by one or more cameras of the device 100 in the manner described herein a consumption gesture made by the user reflecting a consumption of a pill from a plurality of pills stored in the pill box. Various other applications and examples of utility of the present inventive concept are contemplated.

### Exemplary Computing Device

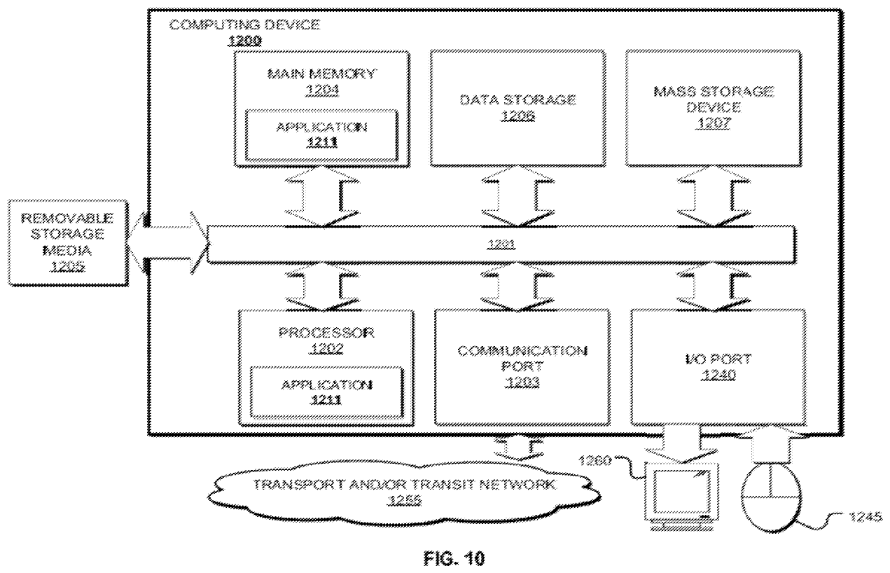

Referring to FIG. 10, a computing device 1200 is illustrated which may take the place of the computing device 102 and be configured, via one or more of an application 1211 or computer-executable instructions, to execute functionality described herein. More particularly, in some embodiments, aspects of the predictive methods herein may be translated to software or machine-level code, which may be installed to and/or executed by the computing device 1200 such that the computing device 1200 is configured to execute functionality described herein. It is contemplated that the computing device 1200 may include any number of devices, such as personal computers, server computers, hand-held or laptop devices, tablet devices, multiprocessor systems, microprocessor-based systems, set top boxes, programmable consumer electronic devices, network PCs, minicomputers, mainframe computers, digital signal processors, state machines, logic circuitries, distributed computing environments, and the like.

The computing device 1200 may include various hardware components, such as a processor 1202, a main memory 1204 (e.g., a system memory), and a system bus 1201 that couples various components of the computing device 1200 to the processor 1202. The system bus 1201 may be any of several types of bus structures including a memory bus or memory controller, a peripheral bus, and a local bus using any of a variety of bus architectures. For example, such architectures may include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computing device 1200 may further include a variety of memory devices and computer-readable media 1207 that includes removable/non-removable media and volatile/nonvolatile media and/or tangible media, but excludes transitory propagated signals. Computer-readable media 1207 may also include computer storage media and communication media. Computer storage media includes removable/non-removable media and volatile/nonvolatile media implemented in any method or technology for storage of information, such as computer-readable instructions, data structures, program modules or other data, such as RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information/data and which may be accessed by the computing device 1200. Communication media includes computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. For example, communication media may include wired media such as a wired network or direct-wired connection and wireless media such as acoustic, RF, infrared, and/or other wireless media, or some combination thereof. Computer-readable media may be embodied as a computer program product, such as software stored on computer storage media.

The main memory 1204 includes computer storage media in the form of volatile/nonvolatile memory such as read only memory (ROM) and random access memory (RAM). A basic input/output system (BIOS), containing the basic routines that help to transfer information between elements within the computing device 1200 (e.g., during start-up) is typically stored in ROM. RAM typically contains data and/or program modules that are immediately accessible to and/or presently being operated on by processor 1202. Further, data storage 1206 in the form of Read-Only Memory (ROM) or otherwise may store an operating system, application programs, and other program modules and program data.

The data storage 1206 may also include other removable/non-removable, volatile/nonvolatile computer storage media. For example, the data storage 1206 may be: a hard disk drive that reads from or writes to non-removable, nonvolatile magnetic media; a magnetic disk drive that reads from or writes to a removable, nonvolatile magnetic disk; a solid state drive; and/or an optical disk drive that reads from or writes to a removable, nonvolatile optical disk such as a CD-ROM or other optical media. Other removable/non-removable, volatile/nonvolatile computer storage media may include magnetic tape cassettes, flash memory cards, digital versatile disks, digital video tape, solid state RAM, solid state ROM, and the like. The drives and their associated computer storage media provide storage of computer-readable instructions, data structures, program modules, and other data for the computing device 1200.

A user may enter commands and information through a user interface 1240 (displayed via a monitor 1260) by engaging input devices 1245 such as a tablet, electronic digitizer, a microphone, keyboard, and/or pointing device, commonly referred to as mouse, trackball or touch pad. Other input devices 1245 may include a joystick, game pad, satellite dish, scanner, or the like. Additionally, voice inputs, gesture inputs (e.g., via hands or fingers), or other natural user input methods may also be used with the appropriate input devices, such as a microphone, camera, tablet, touch pad, glove, or other sensor. These and other input devices 1245 are in operative connection to the processor 1202 and may be coupled to the system bus 1201, but may be connected by other interface and bus structures, such as a parallel port, game port or a universal serial bus (USB). The monitor 1260 or other type of display device may also be connected to the system bus 1201. The monitor 1260 may also be integrated with a touch-screen panel or the like.

The computing device 1200 may be implemented in a networked or cloud-computing environment using logical connections of a network interface 1203 to one or more remote devices, such as a remote computer. The remote computer may be a personal computer, a server, a router, a network PC, a peer device or other common network node, and typically includes many or all of the elements described above relative to the computing device 1200. The logical connection may include one or more local area networks (LAN) and one or more wide area networks (WAN), but may also include other networks. Such networking environments are commonplace in offices, enterprise-wide computer networks, intranets and the Internet.

When used in a networked or cloud-computing environment, the computing device 1200 may be connected to a public and/or private network through the network interface 1203. In such embodiments, a modem or other means for establishing communications over the network is connected to the system bus 1201 via the network interface 1203 or other appropriate mechanism. A wireless networking component including an interface and antenna may be coupled through a suitable device such as an access point or peer computer to a network. In a networked environment, program modules depicted relative to the computing device 1200, or portions thereof, may be stored in the remote memory storage device.

Certain embodiments may be described herein as including one or more modules. Such modules are hardware-implemented, and thus include at least one tangible unit capable of performing certain operations and may be configured or arranged in a certain manner. For example, a hardware-implemented module may comprise dedicated circuitry that is permanently configured (e.g., as a special-purpose processor, such as a field-programmable gate array (FPGA) or an application-specific integrated circuit (ASIC)) to perform certain operations. A hardware-implemented module may also comprise programmable circuitry (e.g., as encompassed within a general-purpose processor or other programmable processor) that is temporarily configured by software or firmware to perform certain operations. In some example embodiments, one or more computer systems (e.g., a standalone system, a client and/or server computer system, or a peer-to-peer computer system) or one or more processors may be configured by software (e.g., an application or application portion) as a hardware-implemented module that operates to perform certain operations as described herein.

Accordingly, the term “hardware-implemented module” encompasses a tangible entity, be that an entity that is physically constructed, permanently configured (e.g., hardwired), or temporarily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure the processor 1202, for example, to constitute a particular hardware-implemented module at one instance of time and to constitute a different hardware-implemented module at a different instance of time.

Hardware-implemented modules may provide information to, and/or receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and may store the output of that operation in a memory device to which it is communicatively coupled. A further hardware-implemented module may then, at a later time, access the memory device to retrieve and process the stored output. Hardware-implemented modules may also initiate communications with input or output devices.

Computing systems or devices referenced herein may include desktop computers, laptops, tablets e-readers, personal digital assistants, smartphones, gaming devices, servers, and the like. The computing devices may access computer-readable media that include computer-readable storage media and data transmission media. In some embodiments, the computer-readable storage media are tangible storage devices that do not include a transitory propagating signal. Examples include memory such as primary memory, cache memory, and secondary memory (e.g., DVD) and other storage devices. The computer-readable storage media may have instructions recorded on them or may be encoded with computer-executable instructions or logic that implements aspects of the functionality described herein. The data transmission media may be used for transmitting data via transitory, propagating signals or carrier waves (e.g., electromagnetism) via a wired or wireless connection.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A system for inferring hand pose and movement, comprising:
a device positioned along a wrist defined by a hand of a user, the device including a camera and an inertial measurement unit (IMU), each of the camera and the IMU being in operative communication with a processor, the processor being configured to:
(i) access a plurality of multimodal datasets, each of the plurality of multimodal datasets comprising a video data stream from the camera and an IMU data stream from the IMU,
(ii) extract a set of features from each of the video data stream and the IMU data stream,
(iii) applying the set of features in combination to a machine learning model to output a gesture,
perform at least one iteration of steps (i)-(iii) to train the machine learning model, and
perform, in real-time, at least one additional iteration of steps (i)-(iii) to infer a pose of the hand relative to a body of the user including a position of fingers of the hand at a given time.

2. The system of claim 1, wherein the processor calculates a change between a number of the set of features to identify a classification of the fingers related to the pose.

3. The system of claim 1, wherein the processor corrects positional errors associated with the IMU by exploiting extracted views of a head of the user, the views of a head of the user defined by the video data stream.

4. The system of claim 1, wherein the IMU data stream includes accelerometery and motion data provided by the IMU, and the video data stream includes video or image data associated with views of fingers of the hand.

5. The system claim 1, wherein the video data stream includes wrist-centric views extracted by the camera including a view of finger tips of the hand, abductor pollicis longus of muscle of the hand which pull in a thumb of the hand for grasping, and a size of a channel defined between a hypothenar and thenar eminences associated with the hand.

6. The system of claim 1, further comprising a mobile platform in communication with the device operable to display feedback and provide real-time guidance to the user.

7. A method for inferring hand pose and movement, comprising:
training a machine learning model implemented by a processor of a device positioned along a wrist defined along a hand of a user to provide an output that adapts to the user over time, by:
accessing a first multimodal dataset comprising a first video data stream from a camera of the device and a first IMU data stream from an IMU of the device as the user performs a predetermined set of gestures,
extracting a first set of features collectively from each of the first video data stream and the first IMU data stream, and
applying the first set of features in combination to the machine learning model to output a gesture; and
inferring a gesture based upon a pose of the hand by:
accessing a second multimodal dataset comprising a second video data stream from the camera of the device and a second IMU data stream from the IMU of the device,
extracting a second set of features collectively from each of the second video data stream and the second IMU data stream, and
applying the second set of features to the machine learning model as trained to output the gesture.

8. The method of claim 7, further comprising executing by the processor a neural network as the user is prompted to perform a predetermined set of stereotypical movements to train the processor to interpret a fixed morphology and movements unique to the user.

9. The method of claim 7, further comprising interpreting, by the processor, motion data directly from the first IMU data stream and the second IMU data stream.

10. The method of claim 7, further comprising inferring by the processor in view of the second video data stream a position of the hand relative to a body of the user by identifying a position on a face of the user to which the hand is pointing.

11. The method of claim 7, further comprising tracking subsequent movements of the hand according to pre-set goals associated with predefined indices of compliance.

12. The method of claim 7, further comprising:
inferring by the processor in view of the second video data stream a pointing gesture from the hand, the pointing gesture directed at a connected device in operable communication with the device positioned along the wrist of the user.

13. The method of claim 12, wherein the pointing gesture is interpretable by the processor as an instruction to select the connected device for a predetermined control operation.

14. The method of claim 12, further comprising inferring by the processor in view of the second video data stream a control gesture subsequent to the pointing gesture, the control gesture indicative of an intended control instruction for transmission from the device along the wrist to the connected device.

14. The method of claim 14, wherein the connected device is a light device and the control gesture defines an instruction to engage a power switch of the light device.

15. The method of claim 14, wherein the connected device is a robotic device, and the control gesture defines an instruction to move the robotic device to a desired position.

16. The method of claim 7, further comprising:
accessing information from a pill box in operable communication with the processor, the information indicating that the pill box was opened at a first time and closed at a second time after the first time by the user, and
accessing by the processor in view of the second video data stream a consumption gesture made by the user reflecting a consumption of a pill from a plurality of pills stored in the pill box.

17. The method of claim 16, further comprising:
logging the consumption of the pill by the processor at a third time subsequent to the first time, and
tracking by the processor the consumption of the pill and consumptions of other ones of the plurality of pills to track pill ingestion for the user.

18. A system for personalized hand gesture monitoring, comprising:
a device positioned proximate to a hand of a user, comprising:
a plurality of cameras that capture image data associated with a hand of the user including a first camera that captures a first portion of the image data along a ventral side of a wrist of the user and a second camera that captures a second portion of the image data along a dorsal side of the wrist of the user;
at least one sensor that provides sensor data including a position and movement of the device; and
a processor that accesses image data from the plurality of cameras and sensor data from the at least one sensor to train a model to interpret a plurality of gestures, and identify a gesture of the plurality of gestures by implementing the model as trained.

19. A tangible, non-transitory, computer-readable media having instructions encoded thereon, such that a processor executing the instructions is operable to:
access a multimodal dataset based on information from an IMU and a camera positioned along a hand of a body of a user; and
infer a position of the hand relative to the body by extracting features from the multimodal dataset, and applying the features to a predetermined machine learning model configured to predict a gesture.

20. The tangible, non-transitory, computer-readable media of claim 12 having further instructions encoded thereon, such that the processor executing the instructions is further operable to train with the predetermined machine learning model as the user is prompted to perform a predetermined set of movements such that the processor executing the predetermined machine learning model is further configured to provide an output that adapts to the user over time.
